(19) United States
(12) Patent Application Publication
(10) Pub. No.: US 2026/0244132 A1
(43) Pub. Date: Aug. 20, 2026

(54) IMAGE FORMING APPARATUS AND METHOD OF CONTROLLING THE SAME

(71) Applicant: CANON KABUSHIKI KAISHA, Tokyo (JP)

(72) Inventor: MASATOSHI ITOH, Shizuoka (JP)

(21) Appl. No.: 19/540,143

(22) Filed: Feb. 13, 2026

(30) Foreign Application Priority Data
Feb. 17, 2025 (JP) 2025-023706

(51) Int. Cl. G03G 15/00; G03G 15/16; G03G 21/16; H02P 21/18

(52) U.S. Cl. CPC G03G 15/50; G03G 15/1615; G03G 15/5008; G03G 21/1647; H02P 21/18

(57) ABSTRACT

An image forming apparatus comprises at least one motor, a motor controller that rotates the motor, and a drive transmitting member that transmits a driving force of the motor to a load. The image forming apparatus detects torque of the motor generated by transmission of the driving force to the load by the drive transmitting member, obtains amplitude of the torque that has been detected, and determines that the load or the drive transmitting member has an abnormality in a case where the amplitude of the torque exceeds a predetermined value.

### BACKGROUND

### Field of the Technology

The present disclosure relates to an image forming apparatus and a method of controlling the same.

### Description of the Related Art

An image forming apparatus includes units that are assumed to be replaced periodically, and these are, for example, a toner cartridge, a fixing device, and the like. In a case where the toner is consumed or in a case where an image cannot be normally formed due to wear of a roller of the fixing device, a normal image can be formed by replacing them. Therefore, the image forming apparatus generally adopts a configuration that allows even a user to easily replace these units. Japanese Patent Laid-Open No. 2009-217131 describes a technique for preventing a failure in a case where a fixing device that can be replaced by a user is not normally mounted. It describes a technique for checking whether a replaceable unit is normally mounted by using existing means such as a means for detecting a coupling state between the fixing device and an apparatus main body and a means for detecting a recording medium pinched and conveyed with a pressing rotating member and a heating rotary member of the fixing device.

Space and cost are necessary in order to dispose sensors that check whether a user-replaceable unit is normally mounted as in Japanese Patent Laid-Open No. 2009-217131, in the replaceable unit. In a case where the user-replaceable unit is not normally mounted to the main body, a gear that transmits a driving force to the unit does not engage, and there is a concern of occurrence of vibration, banding due to vibration, abnormal noise, and the like. Therefore, there is a need to detect whether the replaceable unit is correctly mounted without requiring a space or cost, and to notify the user or a service man in a case where the mounting is not correct.

### SUMMARY

Embodiments of the present disclosure eliminate the above-mentioned issues with conventional technology.

A feature of embodiments of the present disclosure is to provide a technique that can detect whether, for example, a replaceable unit that is a load of a motor is correctly mounted, without requiring a space or cost.

According to embodiments of the present disclosure, there is provided an image forming apparatus, comprising: at least one motor; a motor controller that rotates the motor; a drive transmitting member that transmits a driving force of the motor to a load; and one or more controllers including one or more processors and one or more memories, wherein the one or more controllers are configured to: detects torque of the motor generated by transmission of the driving force to the load by the drive transmitting member; obtain amplitude of the torque that has been detected; and determine that the load or the drive transmitting member has an abnormality in a case where the amplitude of the torque exceeds a predetermined value.

Further features of the various embodiments will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a schematic configuration diagram of a tandem type of color image forming apparatus using an electrophotographic process according to a first embodiment of the present disclosure.

FIG. 2 is a diagram for describing a motor control unit according to the first embodiment.

FIG. 3 depicts a view illustrating a configuration of an A motor according to the first embodiment.

FIG. 4A is a block diagram for describing an algorithm of motor control according to the first embodiment.

FIG. 4B is a block diagram for describing an algorithm of speed control based on an estimated speed value in a motor control algorithm performed by a microcomputer according to the first embodiment.

FIGS. 5A to 5C depict views for describing a relationship between rotor positions of the motor according to the first embodiment.

FIGS. 6A and 6B depict views for describing a drive configuration of the A motor according to the first embodiment.

FIGS. 7A and 7B depict views for describing a current value of the A motor when the A motor according to the first embodiment is rotated.

FIG. 8 depicts a view for describing a method of calculating a current ripple value of the A motor according to the first embodiment.

FIG. 9 depicts a view illustrating an example of an average current ripple value in a case where a driving force of the A motor is normally transmitted to a photosensitive member and in a case where the photosensitive member is in an incomplete mounted state in the first embodiment.

FIGS. 10A and 10B are flowcharts for describing processing by a color image forming apparatus according to the first embodiment.

FIG. 11 is a block diagram for describing an algorithm of motor control according to a second embodiment of the present disclosure.

FIG. 12 depicts a view illustrating an example of a relationship between an engaging frequency and one rotational frequency of a gear of a drive train for each unit to be driven by the A motor.

FIG. 13 is a flowchart for describing processing by a color image forming apparatus according to the second embodiment.

### DESCRIPTION OF THE EMBODIMENTS

Example embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

### First Embodiment

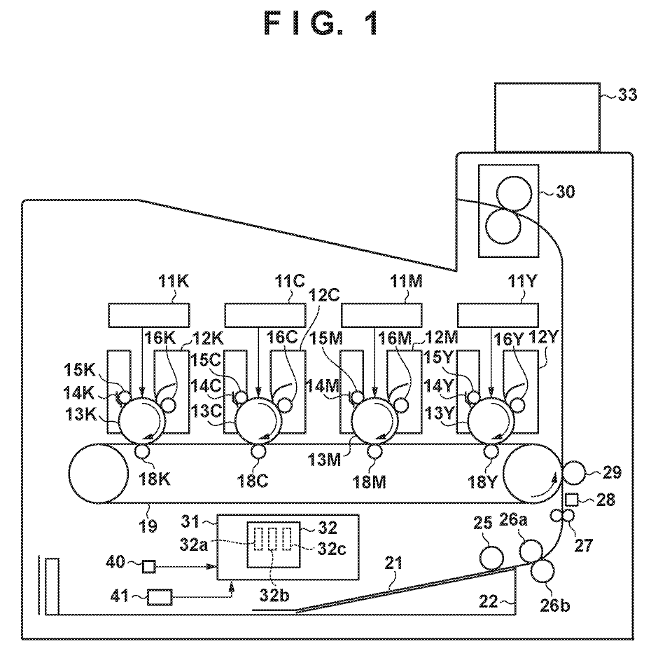

FIG. 1 is a schematic configuration diagram of a tandem type of color image forming apparatus using an electrophotographic process according to a first embodiment of the present disclosure. An image forming operation regarding the configuration of the image forming apparatus according to the first embodiment will be described with reference to the drawing.

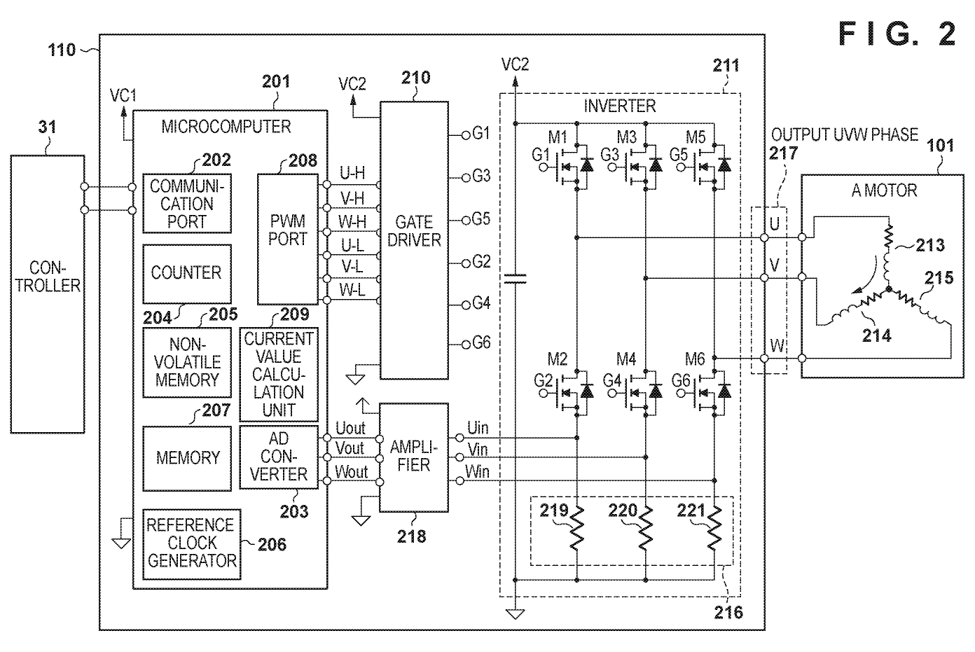

The tandem type of color image forming apparatus is configured to be able to form a full-color image by superimposing toners of four colors of yellow (Y), magenta (M), cyan (C), and black (K). Laser scanners (11Y, 11M, 11C, and 11K) and cartridges (12Y, 12M, 12C, and 12K) are provided for image forming of each color. Hereinafter, Y, M, C, and K given to reference numerals represent parts (components) corresponding to yellow, magenta, cyan, and black, respectively. The respective cartridges include photosensitive members (13Y, 13M, 13C, and 13K) that rotate in the direction of arrows in the drawing, and photosensitive member cleaners (14Y, 14M, 14C, and 14K), charging rollers (15Y, 15M, 15C, and 15K), and developing rollers (16Y, 16M, 16C, and 16K) that are provided so as to be in contact with the photosensitive members. Furthermore, the photosensitive member of each color is provided with an intermediate transfer belt 19 in contact therewith, and a primary transfer roller (18Y, 18M, 18C, or 18K) is installed so as to sandwich and face this intermediate transfer belt 19. The photosensitive members (13Y, 13M, and 13C) and a fixing device 30 are rotationally driven by an A motor 101 (FIG. 2), and the intermediate transfer belt 19 and the photosensitive member 13K are rotationally driven by a B motor (not illustrated). The developing rollers (16Y, 16M, 16C, and 16K) are rotationally driven by a C motor (not illustrated). The A motor 101, the B motor, and the C motor are all DC brushless motors, and the choice of which motor to rotationally drive each roller is not limited to the first embodiment.

A paper feed roller 25, separation rollers 26a and 26b, and a registration roller 27 are provided downstream in conveyance from a cassette 22 that stores paper 21, and a conveyance sensor 28 is provided in a vicinity of a downstream side in a paper conveyance direction of the registration roller 27. Furthermore, a secondary transfer roller 29 is disposed so as to be in contact with the intermediate transfer belt 19 on a downstream side of the conveyance path of the conveyance sensor 28, and the fixing device 30 is disposed downstream of the secondary transfer roller 29.

A controller (printer control unit) 31 is a control unit of the color image forming apparatus, and includes a central processing unit (CPU) 32 including a ROM 32a, a RAM 32b, and a timer 32c, and various input/output control circuits (not illustrated). A display panel 33 displays a screen by a signal from the CPU 32.

Next, an electrophotographic process will be briefly described. The surfaces of the photosensitive members (13Y, 13M, 13C, and 13K) are uniformly charged by the charging rollers (15Y, 15M, 15C, and 15K) in a dark place in the cartridges (12Y, 12M, 12C, and 12K). The photosensitive members (13Y, 13M, and 13C) are configured to rotate by driving and transmitting the driving force of the A motor 101 by a gear. Similarly, the photosensitive member 13K and the intermediate transfer belt 19 are configured to rotate by driving and transmitting the driving force of the B motor by the gear. Next, the surfaces of the photosensitive members (13Y to 13K) are irradiated with laser light modulated according to image data by the laser scanners (11Y to 11K), and electrification charges of the parts irradiated with the laser light are removed, whereby electrostatic latent images are formed on the surfaces of the photosensitive members (13Y to 13K). In the developer, a toner is caused to adhere to the electrostatic latent images on the photosensitive members (13Y to 13K) by a developing bias from the developing rollers (16Y to 16K) holding a certain amount of toner layers, thereby forming a toner image of each color on the surface of the corresponding photosensitive member (13Y to 13K).

The toner images formed on the surfaces of the photosensitive members (13Y to 13K) are attracted to the intermediate transfer belt 19 by a primary transfer bias applied to the primary transfer rollers (18Y to 18K) at nip portions between these photosensitive members and the intermediate transfer belt 19.

Furthermore, the CPU 32 controls an image forming timing in each of the cartridges (12Y to 12K) by the timing corresponding to the belt conveyance speed, and sequentially transfers toner images of the respective colors onto the intermediate transfer belt 19. In this manner, a full-color image is finally formed on the intermediate transfer belt 19. On the other hand, the paper 21 in the cassette 22 is conveyed by the paper feed roller 25, and only one piece of the paper 21 passes through the registration roller 27 and is conveyed to the secondary transfer roller 29 by the separation rollers 26a and 26b. Thereafter, the toner image on the intermediate transfer belt 19 is transferred to the paper 21 at the nip portion between the secondary transfer roller 29 and the intermediate transfer belt 19 downstream of the registration roller 27. Finally, the toner image on the paper 21 is subjected to a heat fixing process by the fixing device 30 that rotates by driving and transmitting the driving force of the A motor 101 by the gear. The paper on which the image has been fixed is discharged to the outside of the image forming apparatus.

The color image forming apparatus includes an environment temperature sensor 40 that measures the environment temperature of the outside air, and can set image forming according to the measured environment temperature. A sensor group 41 includes a sensor that detects opening and closing of a cartridge door that is opened and closed for replacing the cartridge and opening and closing of a fixing device door for inserting the fixing device.

Next, a configuration for rotating the A motor 101 will be described.

FIG. 2 depicts a view for describing a motor control unit 110 according to the first embodiment.

The motor control unit 110 drives the A motor 101 sensorlessly. The motor control unit 110 includes an arithmetic processing unit using a microcomputer 201. The microcomputer 201 incorporates a communication port 202, an AD converter 203, a counter 204, a nonvolatile memory 205, a reference clock generator 206, a memory 207, a pulse width modulation (PWM) port 208, and a current value calculation unit 209, and operates with VC1 = 3.3 V being supplied from a low voltage source. The counter 204 performs a counting operation based on the reference clock generated by the reference clock generator 206, and, based on the count value, measures the period of an input pulse, generates a PWM signal, and the like. The PWM port 208 includes six terminals and outputs PWM signals of three high level side signals (U-H, V-H, and W-H) and three low level side signals (U-L, V-L, and W-L).

The motor control unit 110 includes a three-phase inverter 211 including three switching elements on the high level side (M1, M3, and M5) and three switching elements on the low level side (M2, M4, and M6) as voltage applying units. As a switching element, for example, a transistor or an FET can be used. Each switching element is connected to the PWM port 208 via a gate driver 210, and can be controlled to be turned on/off by a PWM signal. Regarding the gate driver 210 and each switching element, G1, G2, ..., and G6 of the gate driver 210 are connected to G1 of the switching element M1, G2 of the switching element M2, ..., and G6 of the switching element M6, respectively. Each switching element is turned on when the PWM signal is at a high level, and is turned off when the PWM signal is at a low level.

U, V, and W-phase outputs 217 of the inverter 211 are connected to coils 213, 214, and 215, respectively, of the A motor 101, and can control coil currents of the coils 213, 214, and 215. The coil currents of the coils 213, 214, and 215 are converted into voltages by a current detecting unit 216 including current detection resistors 219, 220, and 221. The voltages are amplified by an amplifier 218 and input to the AD converter 203 of the microcomputer 201 with an offset voltage being further applied. Note that the voltage values detected by the current detecting unit 216 are described as Uin, Vin, and Win. Here, the voltage value obtained from the resistor 219 is Uin, the voltage value obtained from the resistor 220 is Vin, and the voltage value obtained from the resistor 221 is Win. The voltage values amplified by the amplifier 218 are defined as Uout, Vout, and Wout. The current value calculation unit 209 treats, as positive, a case where a current flows from the inverter 211 to the A motor 101, and performs a predetermined calculation on A/D converted data (hereinafter, described as an AD value) to calculate a current value flowing through each resistor. Next, the structure of the A motor 101 will be described.

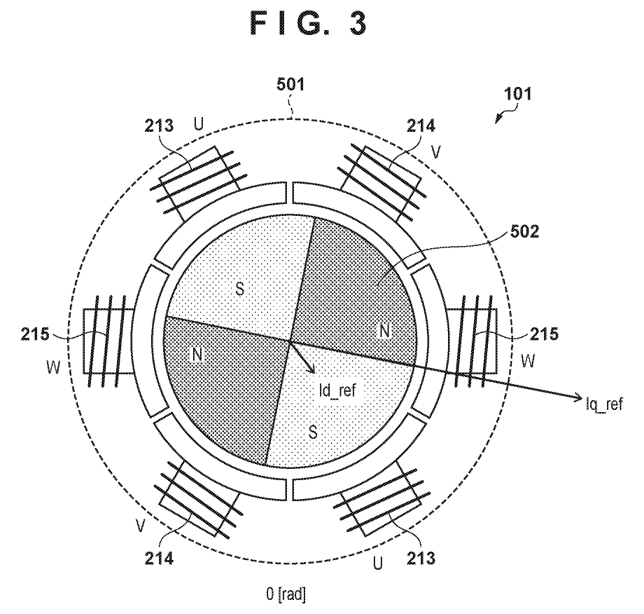

FIG. 3 depicts a view illustrating the configuration of the A motor 101 according to the first embodiment.

The A motor 101 includes a 6-slot stator 501 and a 4-pole rotor 502, and the stator 501 includes the coils 213, 214, and 215 of U-phase, V-phase, and W-phase, respectively. The rotor 502 includes permanent magnets and includes two sets of N poles/S poles. For the sake of simplicity, the number of poles of the rotor 502 is assumed to be four. Since the number of poles is 4, a position at which the rotor 502 rotates counterclockwise by π/2 [rad] at a mechanical angle with reference to a position facing the coil 213 corresponds to an electrical angle π [rad]. For convenience, the counterclockwise direction is set as the positive rotation direction. In sensorless vector control, let a current value flowing in a direction facing the rotor 502 be Id, and let a current value flowing in a direction rotated counterclockwise by π/2 [rad] in the rotation direction at an electrical angle therefrom be Iq. Id is a current value that does not contribute to the rotational torque, and Iq is a current that contributes to the rotational torque (hereinafter, may be simply called torque). Id_ref is a current command value of the current value Id, and Iq_ref is a current command value of the current value Iq.

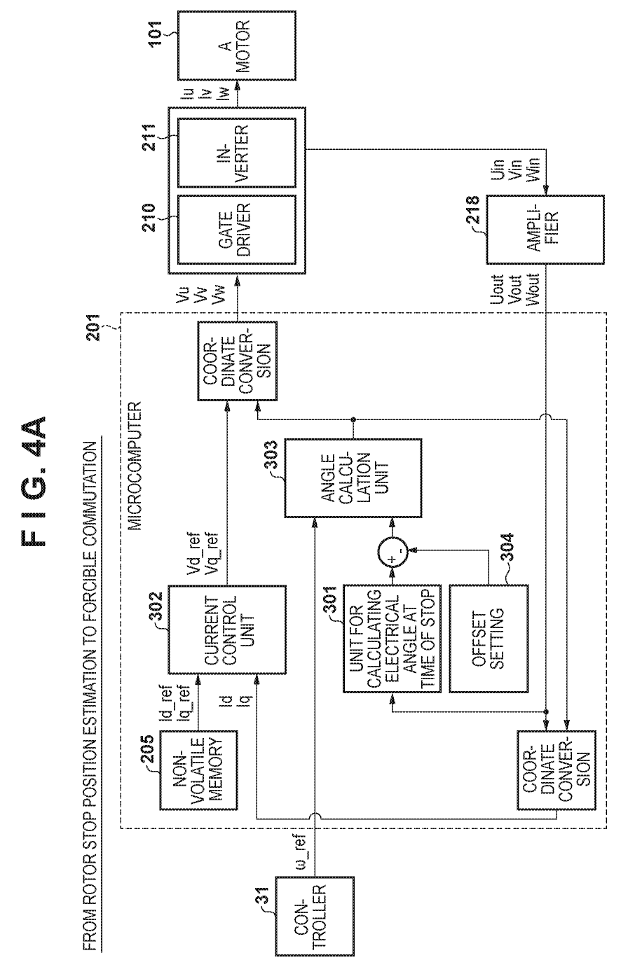

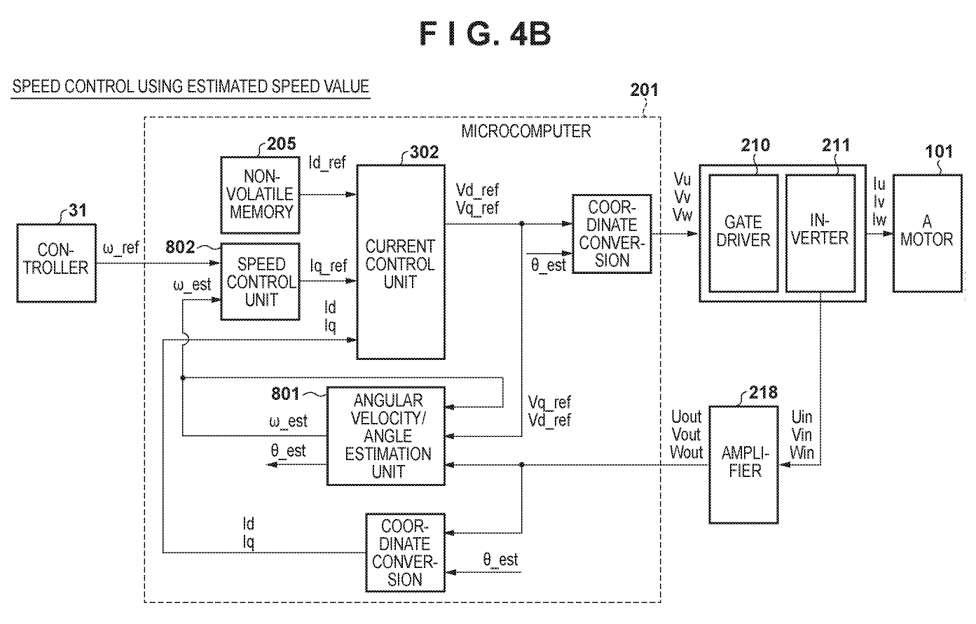

FIG. 4A is a block diagram for describing an algorithm of motor control according to the first embodiment of the present disclosure. With reference to this drawing, the algorithm of motor control performed by the microcomputer 201 will be described with an example of a case where the rotor position is estimated from an induced voltage of the motor to control the motor rotational speed.

This algorithm is divided into three types, i.e., rotor stop position estimation, forcible commutation, and speed control based on an estimated speed value. First, the rotor stop position estimation will be described.

The rotor stop position estimation is performed by a unit for calculating an electrical angle at the time of stop 301. Methods of rotor stop position detection include a method using a phenomenon in which the inductance of each coil of U, V, and W changes depending on the rotor stop position. Specifically, a predetermined voltage is applied to a combination of coils of U-V, U-W, V-W, V-U, W-U, and W-V, and the magnitude of the inductance of each coil is determined based on the magnitude of the coil current flowing at that time. Then, the rotor stop position is detected based on the result. (See, for example, Japanese Patent Laid-Open No. 2015-104263).

A three-phase alternating current phase when the coils 213, 214, and 215 are energized such that Id = 0 [A] in a state where the S-pole of the rotor 502 faces the coil 213 is defined as an electrical angle = 0 [rad]. In a case of determining that the rotor 502 faces the coil 213, the unit for calculating the electrical angle at the time of stop 301 outputs a reference electrical angle θ_std = 0 [rad].

Next, a control algorithm of forcible commutation will be described with an example of a case of the reference electrical angle θ_std = 0 [rad].

At the time of starting the motor, since no induced voltage occurs, speed feedback control is not performed, and the motor is driven by forcible commutation. A current control unit 302 performs current feedback control based on Id_ref and Iq_ref corresponding to current command values stored in advance in the nonvolatile memory 205 and current values Id and Iq corresponding to output torque of the A motor 101. Then, voltage command values Vd_ref and Vq_ref are output. Id_ref, Iq_ref, Id, Iq, Vd_ref, and Vq_ref indicate current command values, currents, and voltage command values, respectively, in a rotor coordinate system.

A coordinate conversion unit performs conversion from the rotor coordinate system (d, q) to a stator coordinate system (U, V, W) or from the stator coordinate system (U, V, W) to the rotor coordinate system (d, q). On the other hand, an angle calculation unit 303 calculates a rotor position θ_ref by integrating a speed command value ω_ref input from a controller 31 into an initial electrical angle θ_ini at every predetermined period. The voltage command values Vd_ref and Vq_ref are converted into voltage command values Vu, Vv, and Vw to be actually applied to a U-phase coil, a V-phase coil, and a W-phase coil by the coordinate conversion unit based on the rotor position θ_ref, and are output. In the first embodiment, the initial electrical angle θ_ini means an electrical angle corresponding to an initial excitation phase at the time of starting the motor. The initial electrical angle θ_ini is set to a value in which the offset determined by an offset setting 304 is added to the reference electrical angle θ_std corresponding to the rotor stop position. The above is the description of the control algorithm of forcible commutation.

FIG. 4B is a block diagram for describing an algorithm of speed control based on an estimated speed value in the motor control algorithm performed by the microcomputer 201.

The microcomputer 201 obtains current information Uout, Vout, and Wout corresponding to motor coil currents Iu, Iv, and Iw obtained from the amplifier 218 at the motor rotational speed at which the induced voltage sufficiently occurs. Then, an angular velocity/angle estimation unit 801 estimates a rotor position θ_est and a speed ω_est from the current information Uout, Vout, and Wout and the voltage command values Vu, Vv, and Vw. Then, using the speed command value ω_ref transmitted from the controller 31 and the estimated speed value ω_est that is previously calculated, a speed control unit 802 calculates the current command value Iq_ref for causing the estimated speed value ω_est to follow the speed command value ω_ref. The current control unit 302 calculates the voltage command values Vd_ref and Vq_ref in the rotor coordinate system from the current command value Iq_ref, Id_ref corresponding to the current command value stored in advance in the nonvolatile memory 205, and Id and Iq corresponding to the load current applied to the A motor 101. Finally, from the estimated rotor position θ_est and the voltage command values Vd_ref and Vq_ref in the rotor coordinate system, the coordinate conversion unit obtains the voltage command values Vu, Vv, and Vw to be actually applied to the U-phase coil, the V-phase coil, and the W-phase coil. The above is the description of the speed control based on an estimated speed value.

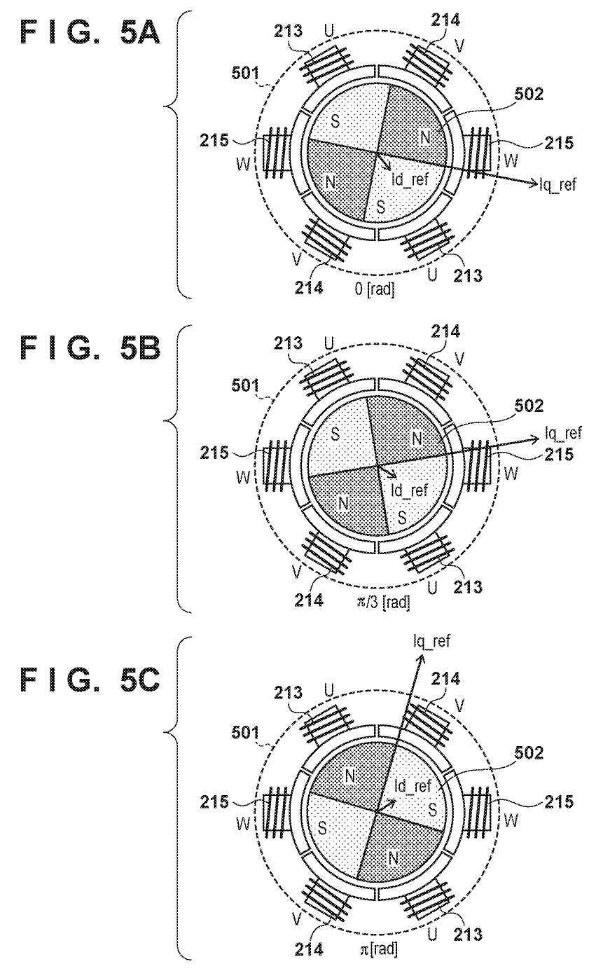

FIGS. 5A to 5C depict views for describing a relationship between rotor positions of the motor according to the first embodiment.

In a state where the rotor 502 is stopped at a position corresponding to the reference electrical angle θ_std = 0 [rad], an offset θ_off = 0 is assumed. FIGS. 5A to 5C illustrate the behavior of the rotor 502 in a case where an excitation phase is switched to the electrical angles 0 [rad], π/3 [rad], and π [rad] in this order.

In FIGS. 5A to 5C, long arrows are vectors representing the current value Iq, and are controlled according to the current command value Iq_ref. Short arrows are vectors representing the current value Id, and are controlled according to the current command value Id_ref. The motor is controlled by a resultant vector current of Iq and Id. During forcible commutation control, both Iq_ref and Id_ref operate with predetermined values prepared in advance. During sensorless control, Id_ref operates with a predetermined value prepared in advance, and Iq_ref operates with a value output from the speed control unit 802.

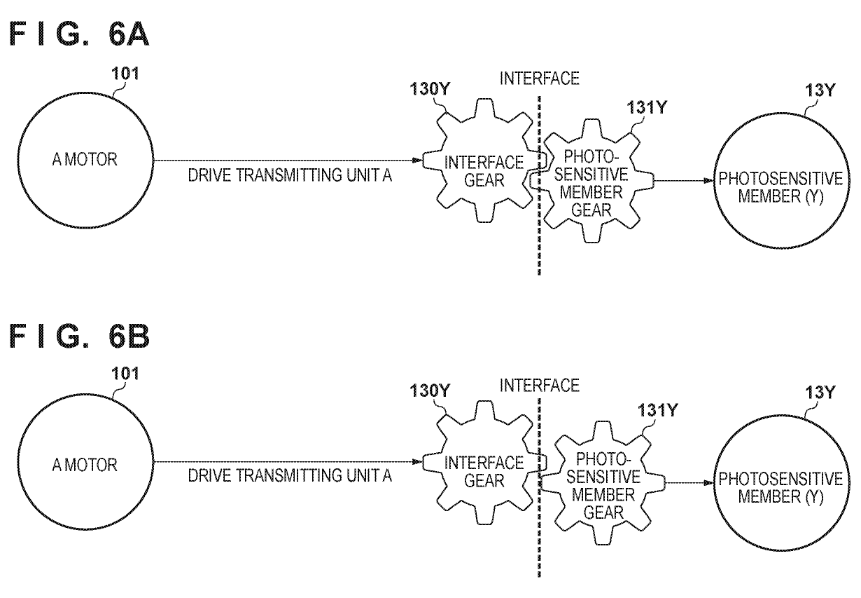

FIGS. 6A and 6B depict views describing a drive configuration of the A motor 101 according to the first embodiment. The load driven by the A motor 101 is the photosensitive members (13Y, 13M, and 13C) and the fixing device 30, but for simplifying the description, a drive configuration for the photosensitive member 13Y will be described below. The drive configurations for the photosensitive members (13M and 13C) and the fixing device 30 are similar to the drive configuration for the photosensitive member 13Y described later, and thus the description thereof will be omitted.

FIGS. 6A and 6B depict views for describing the drive configuration in which the A motor 101 rotationally drives the photosensitive member 13Y and a state during the rotational driving. When the A motor 101 rotates, the driving force by the A motor 101 is driven and transmitted to a photosensitive member interface gear 130Y by a drive transmitting unit A including a gear train. Subsequently, the photosensitive member interface gear 130Y on the main body side of the color image forming apparatus according to the first embodiment and a photosensitive member gear 131Y on the photosensitive member side which is a user-replaceable unit are driven and transmitted by an interface unit. The driving force transmitted to the photosensitive member gear 131Y in the interface unit is transmitted to the photosensitive member 13Y existing coaxially. Here, focusing on the interface units of FIGS. 6A and 6B, it can be seen that the distance between the photosensitive member interface gear 130Y and the photosensitive member gear 131Y is different in FIGS. 6A and 6B. In FIG. 6A, the distance between the photosensitive member interface gear 130Y and the photosensitive member gear 131Y is kept in an appropriate distance relationship, whereas in FIG. 6B, the distance between the photosensitive member interface gear 130Y and the photosensitive member gear 131Y is increased. Regarding FIG. 6B, it is considered to be caused by the fact that the user-replaceable unit is not mounted at a proper position. In the case of FIG. 6B, the distance between the interface gear 130Y and the photosensitive member gear 131Y is too long. Therefore, when the A motor 101 is rotated in this state, the driving force transmission in the interface unit becomes unstable, and there is a possibility that banding or vibration occurs, wear of a gear due to tooth skipping occurs, or abnormal noise occurs.

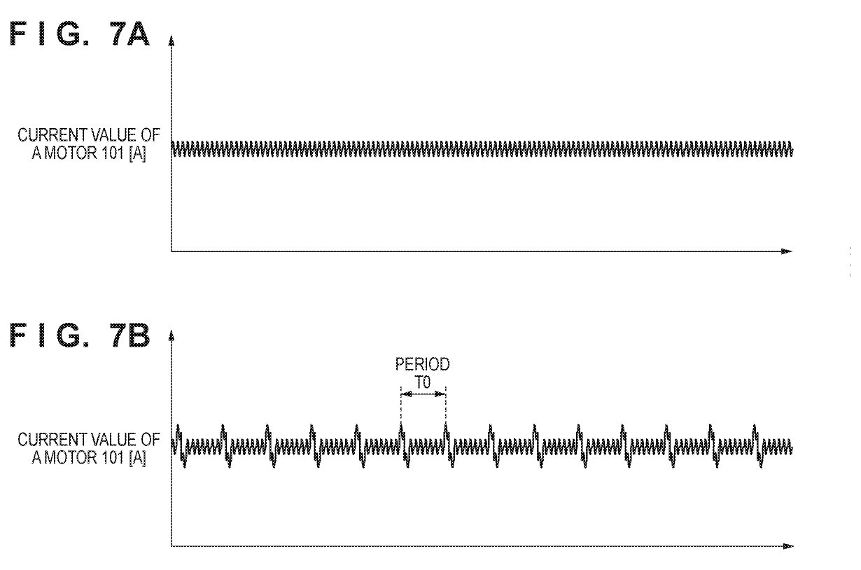

Next, a current value of the A motor 101 when the A motor 101 according to the first embodiment is rotated will be described with reference to FIGS. 7A and 7B.

FIGS. 7A and 7B depict views for describing the current value of the A motor 101 when the A motor 101 according to the first embodiment is rotated. In FIGS. 7A and 7B, the horizontal axis represents time, and the vertical axis represents the current value flowing through the A motor 101.

Since the A motor 101 adjusts the current value so as to have a predetermined speed, the current value of the A motor 101 and the torque value applied on a motor shaft of the A motor 101 have a certain correlation. In particular, in a case where vector control is performed such that Id, which is a current that does not contribute to torque, becomes 0, the correlation between the current value of the A motor 101 and the torque value applied on the motor shaft of the A motor 101 described above becomes stronger.

FIG. 7A shows current value transition of the A motor 101 in a case where the distance relationship between the photosensitive member interface gear 130Y and the photosensitive member gear 131Y is normal as in FIG. 6A. FIG. 7A indicates that the ripple of the current value in a case where the A motor 101 is rotated remains small.

On the other hand, FIG. 7B shows current value transition of the A motor 101 in a state where the distance between the interface gear 130Y and the photosensitive member gear 131Y is too long as in FIG. 6B and the drive transmission in the interface unit is unstable. As for the current value in a case where the A motor 101 is rotated, it can be seen that a periodic torque fluctuation occurs on the motor shaft of the A motor 101 because a periodic ripple occurs. As shown in FIG. 7B, a periodic ripple occurs in the current value of the A motor 101. A period T0 thereof is often a one-tooth period or a one-rotation period of the photosensitive member interface gear 130Y or the photosensitive member gear 131Y in the case of the state as in FIG. 6B, although it depends on a failure state of the gear train in the A motor 101. As in FIG. 6B, in a case where some failure occurs in the gear train, the drive transmission becomes unstable, banding or vibration occurs, and tooth skipping or abnormal noise occurs, torque fluctuation occurs in the one-tooth period or the one-rotation period of the related gear. For this reason, as shown in FIG. 7B, a ripple occurs in the current value of the A motor 101. ‎ Therefore, by detecting the ripple that occurs in the current value of the A motor 101, it is possible to detect a failure of the gear train rotating the A motor 101.

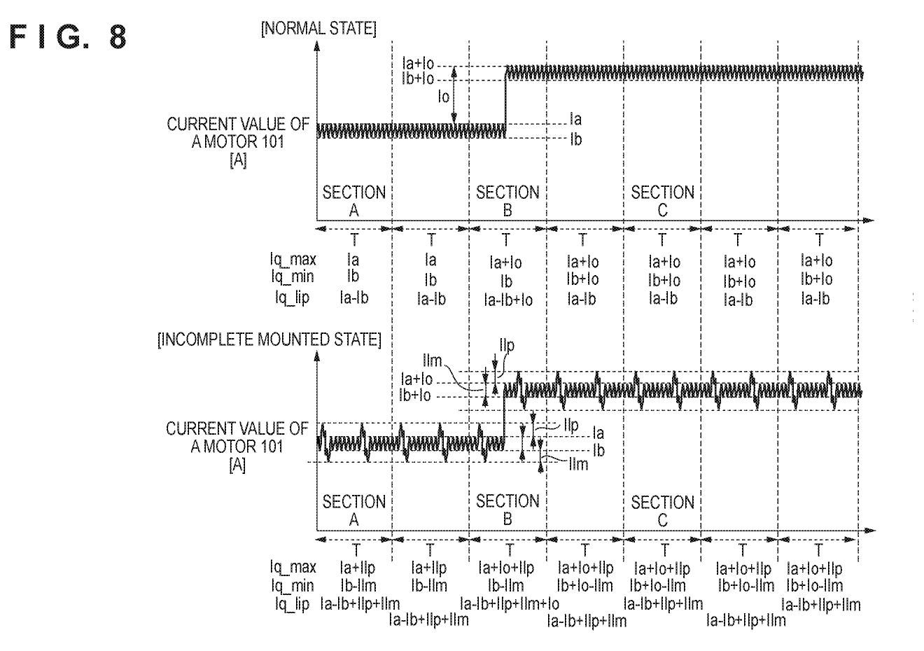

FIG. 8 depicts a view for describing a method of calculating the current ripple value of the A motor 101 according to the first embodiment. FIG. 8 shows current values of the A motor 101 in a case where the driving force of the A motor 101 is normally transmitted to the photosensitive member 13Y and in a case where the photosensitive member 13Y is in an incomplete mounted state. In FIG. 8, the horizontal axis represents time, and the vertical axis represents the current value Iq flowing through the A motor 101.

In a case where the driving force of the A motor 101 is normally transmitted to the photosensitive member 13Y, the current value Iq of the A motor 101 transitions while oscillating at the levels between Ia and Ib as shown in the upper graph of FIG. 8. Then, the current value increases by Io due to the load variation at a predetermined timing, and the current value Iq of the A motor 101 thereafter transitions while oscillating at the levels between Ia + Io and Ib + Io.

A method of calculating the current ripple value according to the first embodiment will be described with reference to a graph in a normal state.

The current value Iq of the A motor 101 is obtained at a predetermined sampling period, and a maximum value Iq_max and a minimum value Iq_min at a predetermined period T are calculated. A current ripple value Iq_lip is calculated from the maximum value Iq_max and the minimum value Iq_min that are calculated. In the case of the normal state of FIG. 8, a method of calculating the current ripple value Iq_lip will be described with a section A, a section B, and a section C as examples. In the section A, Iq_max is Ia, Iq_min is Ib, and Iq_lip is Ia - Ib. In the section B where the load variation of Io occurs, Iq_max is Ia + Io, Iq_min is Ib, and Iq_lip is Ia - Ib + Io. In the section C after the load variation, Iq_max is Ia + Io, Iq_min is Ib + Io, and Iq_lip is Ia - Ib. In such a method of calculating, an average current ripple value Iq_lip_ave is calculated by averaging, in a predetermined period in which the A motor 101 rotates, Iq_lip calculated in each section. The average current ripple value Iq_lip_ave of the seven sections in FIG. 8 is (6 (Ia - Ib) + Ia - Ib + Io)/7 = Ia - Ib + Io/7. By increasing the number of sections for calculating this average value, it is possible to reduce the influence of Io, which is the current due to the load variation in the section C.

Next, transition of the ripple current value of the A motor 101 in an incomplete mounted state will be described.

In a case where the drive transmission is unstable as in the incomplete mounted state, as shown in the lower graph of FIG. 8, not only the current value Iq of the A motor 101 oscillates at the levels between Ia and Ib but also the current value Iq transitions while increasing by Ilp or decreasing by Ilm at a predetermined period. The current value increases by Io due to the load variation at a predetermined timing, and the current value Iq of the A motor 101 thereafter transitions while not only oscillating at the levels between Ia + Io and Ib + Io but also increasing by Ilp or decreasing by Ilm at a predetermined period. In the case of the incomplete mounted state of FIG. 8, a method of calculating the current ripple value Iq_lip will be described using the section A, the section B, and the section C as examples. In the section A, Iq_max is Ia + Ilp, Iq_min is Ib - Ilm, and Iq_lip is Ia - Ib + Ilp + Ilm. In the section B where the load variation of Io occurs, Iq_max is Ia + Ilp + Io, Iq_min is Ib - Ilm, and Iq_lip is Ia - Ib + Ilp + Ilm + Io. In the section C after the load variation, Iq_max is Ia + Ilp + Io, Iq_min is Ib - Ilm + Io, and Iq_lip is Ia - Ib + Ilp + Ilm. In such a method of calculating, an average current ripple value Iq_lip_ave is calculated by averaging, in a predetermined period in which the A motor 101 rotates, Iq_lip calculated in each section. The average current ripple value Iq_lip_ave of the seven sections in the incomplete mounted state in FIG. 8 is Ia - Ib + Ilp + Ilm + Io/7. By increasing the number of sections for calculating this average value, it is possible to reduce the influence of Io, which is the current due to the load variation in the section C.

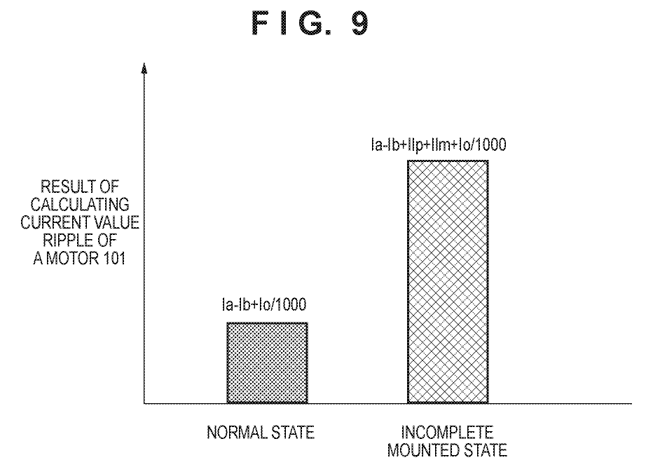

FIG. 9 depicts a view illustrating an example of the average current ripple values in a case where the driving force of the A motor 101 is normally transmitted to the photosensitive member 13Y and in a case where the photosensitive member 13Y is in an incomplete mounted state in the first embodiment. FIG. 9 shows a case where the number of sections for calculating the average value is 1000.

As shown in FIG. 9, it can be seen that the average current ripple value Iq_lip_ave has a large difference between the incomplete mounted state and the normal state. Therefore, in a case where the average current ripple value Iq_lip_ave of the A motor 101 is calculated and the average current ripple value Iq_lip_ave of the A motor 101 is larger than a predetermined value, it can be determined that some failure has occurred in the gear train in the drive train of the A motor 101. In particular, in a case where the average current ripple value Iq_lip_ave is larger than the predetermined value immediately after the cartridge is replaced, it is determined that there is a failure due to the fact that the cartridge is not normally mounted or a sign of occurrence of a failure, and the user can be notified of reinsertion of the cartridge.

In the first embodiment, an example has been described in which a failure up to the photosensitive member gear connected to the drive train of the A motor 101 is detected by the average current ripple value Iq_lip_ave using the current value Iq of the A motor 101. However, the present disclosure can also be applied to, for example, a case where a load connected to the motor is a fixing device, and a failure in the drive train up to the fixing device or incomplete insertion of the fixing device is detected and notified to the user. Therefore, the configuration of the motor and the load to be connected to the motor are not limited to those of the first embodiments. In the first embodiment, the average current ripple value Iq_lip_ave is calculated by calculating a ripple value from the maximum value and the minimum value of the current value in a predetermined period, and obtaining and averaging the sum of the ripple values. However, the present disclosure is not limited to the method of calculating the ripple value in the first embodiment.

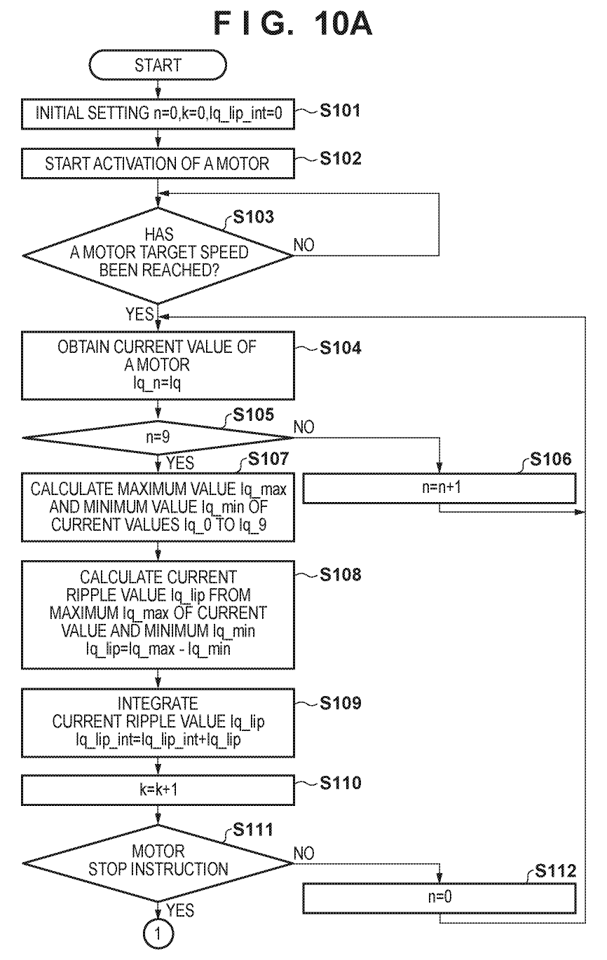

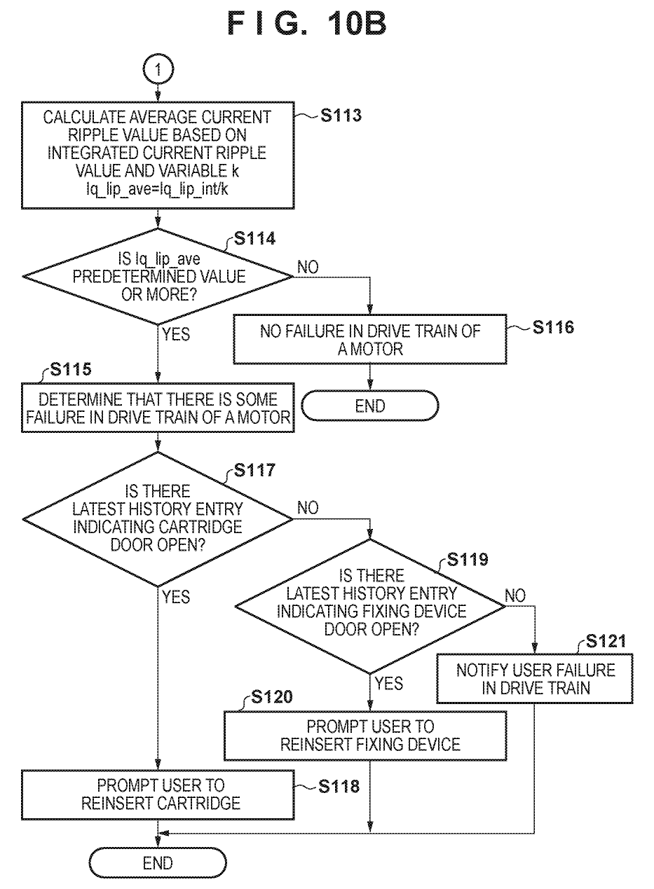

FIGS. 10A and 10B are flowcharts for describing processing by the color image forming apparatus according to the first embodiment of the present disclosure. The processing shown in this flowchart is implemented by the CPU 32 of the controller 31 executing a program stored in the ROM 32a.

When this processing is started, the CPU 32 performs an initial setting (n = 0, k = 0, Iq_lip_int = 0) of each value provided in the RAM 32b in step S101. Here, a variable n is used to count the number of times of obtaining the current value Iq flowing through the A motor 101. A variable k is used to count the number of times of integration to obtain an average of the integrated current ripple values. Iq_lip_int is a variable for integrating Iq_lip in step S108 described later. Next, the processing proceeds to step S102, and the CPU 32 starts activation of the A motor 101. Then, in step S103, the CPU 32 waits for the rotation speed of the A motor 101 to reach a target speed, and then the processing proceeds to step S104. In step S104, the CPU 32 obtains the current value Iq of the A motor 101. This is obtained by calculating each current value flowing through the resistors 219, 220, and 221 based on the voltage value (digital value) input from the AD converter 203 as described with reference to FIG. 2. Then, the current value Iq here is substituted into Iq_n of the RAM 32b. Then, the processing proceeds to step S105, and the CPU 32 determines whether the value of the variable n has become 9, and the processing proceeds to step S106 if it is not 9, the CPU 32 increments the value of the variable n by 1, and the processing proceeds to step S104. When the value of the variable n becomes 9 in step S105, the processing proceeds to step S107. By this, ten current values Iq_0 to Iq_9 are obtained.

In step S107, the CPU 32 calculates the maximum value Iq_max and the minimum value Iq_min of the current values Iq_0 to Iq_9 obtained a plurality of times. Next, the processing proceeds to step S108, and the CPU 32 calculates the current value ripple value Iq_lip from the difference between Iq_max and Iq_min calculated in step S107. Here, the current value ripple value Iq_lip is obtained by Iq_max - Iq_min. Then, the processing proceeds to step S109, and the CPU 32 integrates Iq_lip calculated in step S108. Specifically, Iq_lip_int = Iq_lip_int + Iq_lip is obtained. Then, the processing proceeds to step S110, and the CPU 32 increments the variable k by 1, and the processing proceeds to step S111. In step S111, the CPU 32 determines whether there is a stop instruction for stopping the rotation of the motor, and the processing proceeds to step S112 if there is no stop instruction for the motor, and the CPU 32 returns the variable n to 0, and the processing proceeds to step S104, and the CPU 32 executes similar processing to that described above. When the rotation stop instruction for the motor is input in step S111 in this manner, the processing proceeds to step S113. In step S113, an integrated value of the current value ripple value Iq_lip for the number of times of the value indicated by the variable k is stored in Iq_lip_int.

In step S113, the CPU 32 calculates the average current ripple value Iq_lip_ave based on the current ripple value Iq_lip_int integrated in step S109 and the variable k. Specifically, the average current ripple value Iq_lip_ave = Iq_lip_int/k is obtained. Next, the processing proceeds to step S114, and the CPU 32 determines whether the average current ripple value Iq_lip_ave obtained in step S113 is a predetermined value or more, and the processing proceeds to step S115 if it is determined that Iq_lip_ave is the predetermined value or more, and the CPU 32 determines that there is some failure (abnormality) in the drive train of the A motor 101, and the processing proceeds to step S117. On the other hand, the CPU 32 determines that the average current ripple value Iq_lip_ave is normal if it is determined that the average current ripple value Iq_lip_ave is less than the predetermined value in step S114, the processing proceeds to step S116, and the CPU 32 determines that there is no failure in the drive train of the A motor 101, and ends this processing.

In step S117, the CPU 32 determines whether there is a latest history entry such as one that indicates the opening and closing of the cartridge door detected by a cartridge sensor of the sensor group 41, and the processing proceeds to step S118 if it is determined that there is such a history. In step S118, the CPU 32 determines incomplete insertion due to detaching/attaching of the cartridge, displays a message prompting the user to reinsert the cartridge on the display panel 33 or the like, and ends this processing. On the other hand, in a case that it is determined in step S117 that there is no history entry of opening and closing of the cartridge door for inserting the cartridge by a latest user operation or the like, the processing proceeds to step S119. In step S119, the CPU 32 determines whether there is a latest history entry of opening and closing of the fixing device door detected by a fixing sensor of the sensor group 41. If it is determined that there is such a history entry, the CPU 32 determines incomplete insertion due to detaching/attaching of the fixing device, the processing proceeds to step S120, the CPU 32 displays a message prompting the user to reinsert the fixing device on the display panel 33 or the like, and ends this processing. If it determines in step S119 that there is no history of opening and closing of the fixing device door for inserting the fixing device by the latest user operation or the like, the processing proceeds to step S121. In step S121, the CPU 32 notifies the user or the service man of the possibility of a failure in the drive train of the A motor 101 by the display panel 33 or the like, and ends this processing.

In the first embodiment, identification of a unit in which incomplete mounting may occur such as the cartridge or the fixing device is performed based on the latest opening and closing of the cartridge door or the fixing device door. However, for example, a replacement history may be obtained by information on the cartridge, the nonvolatile memory in the fixing device, or the like, and the unit having a possibility of incomplete mounting may be identified based on the replacement history.

As described above, according to the first embodiment, it is possible to detect incomplete mounting of a user-replaceable unit and a failure of the drive train from the motor without requiring a space or cost. Then, by notifying the user or the service man of the detection result, there is an effect that it is possible to prompt remounting the user-replaceable unit or inspection work of the drive train by the service man.

### Second Embodiment

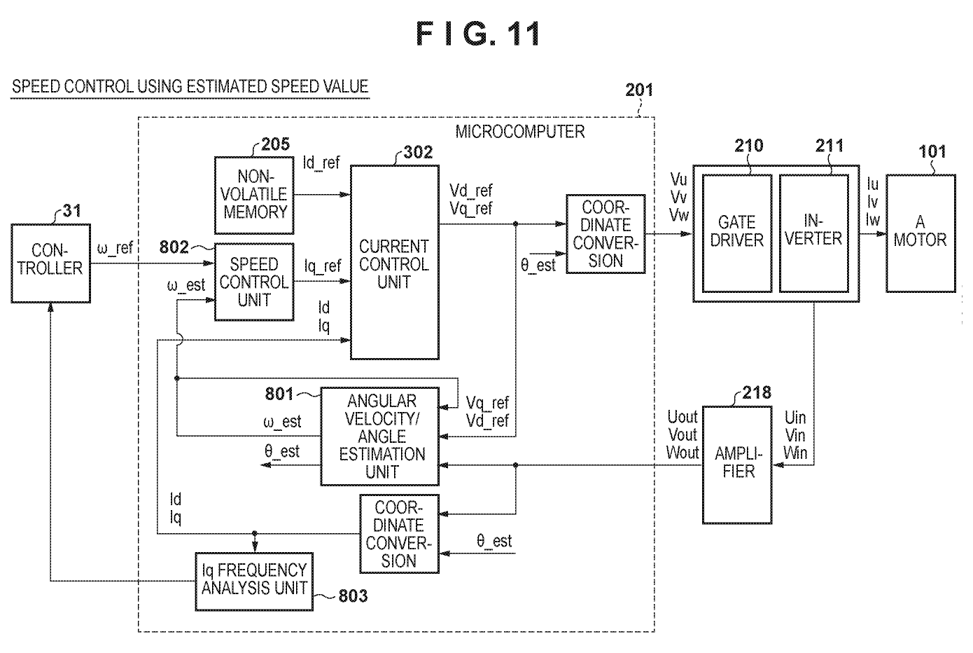

Next, the second embodiment of the present disclosure will be described with reference to FIGS. 11 to 13. However, this second embodiment is merely an example, and the present disclosure is not limited to these configurations. Since the configuration and the like of the color image forming apparatus according to the second embodiment are the same as those of the first embodiment described above, the description thereof will be omitted.

In the first embodiment described above, an example has been described in which a failure in the drive train of the A motor 101 or incomplete mounting of a user-removable unit is detected from the ripple value of a current flowing through the A motor 101. On the other hand, in the second embodiment, an example of subjecting the current value flowing through the A motor 101 to frequency analysis and detecting as to which unit a failure has occurred in will be described.

FIG. 11 is a block diagram for describing an algorithm of motor control according to the second embodiment of the present disclosure. FIG. 11 is a diagram in which a frequency analysis block used in the second embodiment is added to the block diagram (FIG. 4B) regarding the speed control based on an estimated speed value in the motor control algorithm performed by the microcomputer 201.

When the speed of the motor is controlled, Iq, which is a current that contributes to torque, is output after coordinate conversion. The Iq that is output is input to an Iq frequency analysis unit 803 and subjected to frequency analysis by the Iq frequency analysis unit 803, whereby an equivalent of torque fluctuation amount for each frequency can be obtained. With torque fluctuation amount information for each frequency, it is possible to detect in which unit a failure of the gear train occurs, drive transmission becomes unstable, occurrence of banding or vibration, and occurrence of tooth skipping or abnormal noise. As in FIG. 4B of the first embodiment, the microcomputer 201 and the Iq frequency analysis unit 803 exist in the motor control unit 110, and the motor control unit 110, the microcomputer 201, and the Iq frequency analysis unit 803 operate based on an instruction from the CPU 32, which is the printer control unit 31. The speed information, the Iq value, the Iq frequency analysis result, and the like of the A motor 101 calculated by the microcomputer 201 are configured to be transmitted from the microcomputer 201 to the CPU 32.

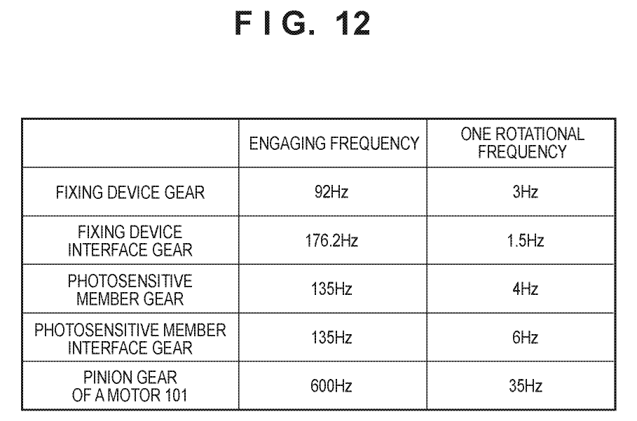

FIG. 12 depicts a view illustrating an example of the relationship between the engaging frequency and one rotational frequency of the gear of the drive train for each unit driven by the A motor 101.

When a failure occurs in the gear train that transmits the driving force to a certain unit and the drive transmission is brought into an unstable state, the torque fluctuation at the engaging frequency or one rotational frequency increases. The engaging frequency and the one rotational frequency are different depending on the number of teeth and the reduction ratio of each of a fixing device gear, a fixing interface gear, a photosensitive member gear, a photosensitive member interface gear, a pinion gear of the A motor 101, and the like. That is, if a frequency whose fluctuation amount is larger than a predetermined value is detected from the torque fluctuation amount for each frequency, it means that a failure occurs in the gear train corresponding to the unit corresponding to the frequency. For example, when a failure such as abnormal noise occurs at the engaging frequency or the one rotational frequency, it is considered that the variation amount at the frequency is larger than a predetermined value. In such a case, it can be said that tooth skipping or the like occurs in the unit corresponding to the frequency.

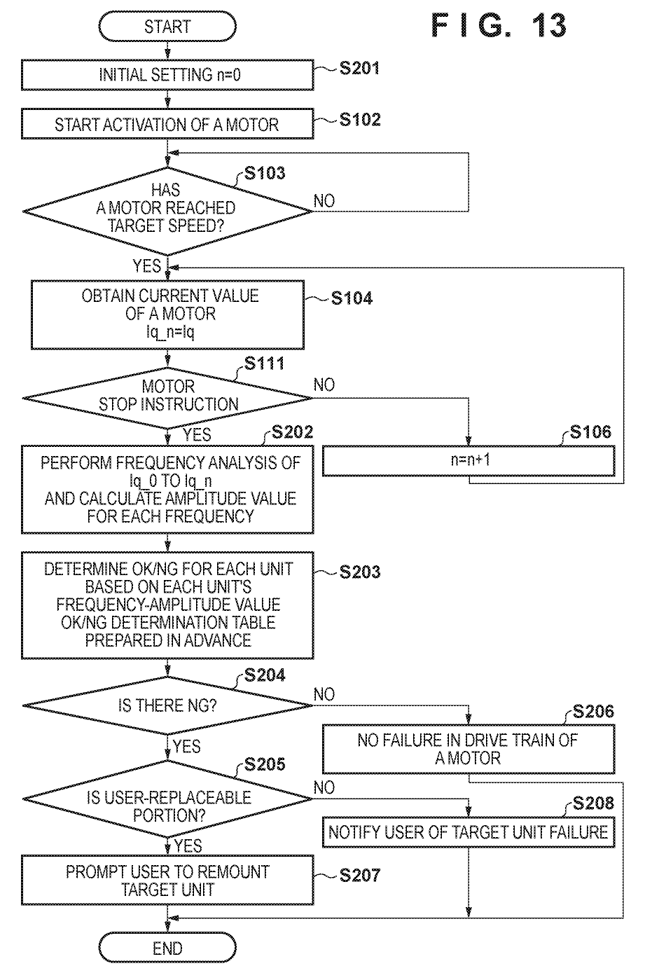

FIG. 13 is a flowchart for describing processing by the color image forming apparatus according to the second embodiment. The processing shown in this flowchart is implemented by the CPU 32 of the controller 31 executing a program stored in the ROM 32a. Note that in FIG. 13, the same processing as that in FIGS. 10A and 10B described above is denoted by the same reference numeral and the descriptions of the same processing is omitted.

When this processing is started, the CPU 32 first performs initial setting (n = 0) in step S201. This variable n is stored in the RAM 32b, and counts the number of times of obtaining the current value Iq flowing through the A motor 101. Next, the processing proceeds to step S102, and the CPU 32 starts activation of the A motor 101, and the processing proceeds to step S104 when the rotation speed of the A motor 101 reaches the target speed in step S103. In step S104, the CPU 32 obtains the current value Iq_n flowing through the A motor 101. Until a stop instruction for the motor is issued in step S111, the CPU 32 keeps obtaining the current value of the A motor 101 while incrementing the variable n by 1 in step S106.

When the stop instruction for the motor is input, the processing proceeds to step S202, and the CPU 32 performs frequency analysis on the waveforms of Iq_0 to Iq_n, which are the current values of the A motor 101 obtained in step S104, to calculate the amplitude value for each frequency. Next, the processing proceeds to step S203, and, based on a table (not illustrated) prepared in advance in which the frequency of each unit and an allowable amplitude value are associated with each other, the CPU 32 determines whether the amplitude value of the frequency that is detected is less than the allowable amplitude value of the table. It is determined as OK in a case of less than the allowable amplitude value, and it is determined as NG (no good) in a case of the allowable amplitude value or more, and it is determined whether OK/NG for each unit. Then, in step S204, the CPU 32 determines whether NG exists, the processing proceeds to step S206 if NG does not exist, and the CPU 32 determines that there is no failure in the drive train regarding the A motor 101, and ends this processing.

On the other hand, the processing proceeds to step S205 if it is determined in step S204 that NG exists, and the CPU 32 determines whether the NG portion is a portion that can be replaced by the user. Here, the processing proceeds to step S207 if it is determined that the NG portion is a portion that can be replaced by the user, and the CPU 32 makes a notification to the user for remounting of the target unit by the display panel 33 or the like, and ends this processing. If it is determined in step S205 that the NG portion is not a user-replaceable portion, the processing proceeds to step S208, and the CPU 32 notifies the user of the failure of the target unit, and ends this processing. In the case of step S208, by notifying the service man, the user requests inspection work on the drive train or the like by the service man.

Note that in the second embodiment, an example has been described in which a failure of the drive train and the unit of the A motor 101 is detected, but the present disclosure is not limited to this. For example, the present disclosure is not limited to the description of the second embodiment as long as it is obtained by frequency analysis on the current value of the A motor 101 by detecting rotation unevenness of the commutation period of the motor itself of the A motor 101, oscillation of control, or the like. A target to be detected may be a part other than the A motor 101.

As described above, according to the second embodiment, it is possible to identify a unit or a gear in which a failure has occurred among the drive train and the load of the A motor. This has an effect of enabling the user to remount a user-replaceable unit or request inspection work on the drive train or the like by the service man.

### Other Embodiments

Embodiments of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to Japanese Patent Application No. 2025-023706, which was filed on February 17, 2025 and which is hereby incorporated by reference herein in its entirety.

What is claimed is:

1. An image forming apparatus, comprising:
at least one motor;
a motor controller that rotates the motor;
a drive transmitting member that transmits a driving force of the motor to a load; and
one or more controllers including one or more processors and one or more memories, wherein the one or more controllers are configured to:
detects torque of the motor generated by transmission of the driving force to the load by the drive transmitting member;
obtain amplitude of the torque that has been detected; and
determine that the load or the drive transmitting member has an abnormality in a case where the amplitude of the torque exceeds a predetermined value.

2. The image forming apparatus according to claim 1, wherein in the obtaining the amplitude of the torque, the one or more controllers obtain a maximum value and a minimum value from a plurality of torques detected a plurality of times, use a difference between the maximum value and the minimum value as the amplitude of the torque, and further obtain, as the amplitude of the torque, an average value of a plurality of amplitudes of the torques detected a plurality of times.

3. The image forming apparatus according to claim 1, wherein in the detection of the torque, the one or more controllers detect the torque based on a current value flowing through the motor.

4. The image forming apparatus according to claim 1, wherein the load includes a unit that can be removed by a user.

5. The image forming apparatus according to claim 4, wherein the unit that can be removed includes a cartridge.

6. The image forming apparatus according to claim 4, wherein the unit that can be removed includes a fixing device.

7. The image forming apparatus according to claim 1, wherein the one or more controllers further notify a user in response to determining that the load or the drive transmitting member has an abnormality.

8. The image forming apparatus according to claim 7, wherein the one or more controllers further detect detaching/attaching of a unit that can be removed by the user,
wherein in a case of determining that the amplitude of the torque exceeds the predetermined value after mounting of the unit that can be removed is detected, the one or more controllers notify that the abnormality is due to the unit that can be removed.

9. The image forming apparatus according to claim 1, wherein the one or more controllers further perform frequency analysis on a waveform of the torque that has been detected, and
wherein the one or more controllers obtain the amplitude of the torque for each frequency in the obtaining of the amplitude of the torque.

10. The image forming apparatus according to claim 9, wherein when in the determining an abnormality in the load or the drive transmitting member, the one or more controllers further determine which of the load and the drive transmitting member has the abnormality based on the amplitude of the torque for each frequency.

11. The image forming apparatus according to claim 1, wherein the motor is a brushless motor.

12. The image forming apparatus according to claim 1, wherein the motor is driven by vector control.

13. A method of controlling an image forming apparatus including at least one motor, a motor controller that rotates the motor, and a drive transmitting member that transmits a driving force of the motor to a load, the method comprising:
detecting torque of the motor generated by transmission of a driving force to the load by the drive transmitting member;
obtaining amplitude of the torque that has been detected; and
determining that the load or the drive transmitting member has an abnormality in a case where the amplitude of the torque that has been obtained exceeds a predetermined value.

14. The method of controlling according to claim 13, further comprising:
notifying a user in response to a determination of an abnormality in the determining.

15. The method of controlling according to claim 14, further comprising:
detecting detaching/attaching of a unit that can be removed by the user,
wherein in a case where the amplitude of the torque is determined to exceed the predetermined value in the determining after mounting of the unit that can be removed is detected, the notifying notifies that the abnormality is due to the unit that can be removed.

16. The method of controlling according to claim 13, further comprising:
perform frequency analysis on a waveform of the torque that has been detected in the detecting,
wherein in the obtaining, the amplitude of the torque for each frequency is obtained.

17. The method of controlling according to claim 16, wherein in the determining, it is determined that which of the load and the drive transmitting member has the abnormality based on the amplitude of the torque for each frequency.
